(19) United States
(12) Patent Application Publication
(10) Pub. No.: US 2024/0112258 A1
(43) Pub. Date: Apr. 4, 2024

(54) SYSTEM, METHOD, AND COMPUTER PROGRAM TO FORMULATE AND VISUALIZE INSIGHTS FOR STOCK TRADING BASED ON OPTIMAL HISTOGRAM VALUES AND MACHINE LEARNING CONFIDENCE SCORES

(71) Applicant: JPMorgan Chase Bank, N.A., New York, NY (US)

(72) Inventor: Alan YEUNG, Jersey City, NJ (US)

(73) Assignee: JPMorgan Chase Bank, N.A., New York, NY (US)

(21) Appl. No.: 17/956,277

(22) Filed: Sep. 29, 2022

(51) Int. Cl. G06Q 40/04

(52) U.S. Cl. CPC G06Q 40/04

(57) ABSTRACT

Various methods, apparatuses/systems, and media for generating a confidence score for trading an equity are disclosed. A processor transforms received historical raw data associated with trading an equity into corresponding bear and bull cycles by applying a predefined algorithm; calculates days in group (DIG) values and histogram values for every bear and bull cycles associated with the equity; receives new raw data associated with the equity; implements a machine learning model that receives the calculated DIG values, the histogram values, the new raw data, and buy or sell labels as input and outputs a confidence score to buy or sell the equity; generates a boxplot digital display onto the user interface that displays the confidence score, the DIG values, and the histogram values; and receives user input via the user interface to buy or sell the equity based on determining that the confidence score meets a predefined threshold value.

### TECHNICAL FIELD

This disclosure generally relates to data processing, and, more particularly, to methods and apparatuses for implementing a platform and language agnostic smart data processing module configured to formulate and allow visualization of insights data for equity trading based on optimal histogram values data and machine learning confidence scores data.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, a wide variety of business functions are commonly supported by software applications and tools, i.e., business intelligence (BI) tools. For instance, software has been directed to data processing, data migration, monitoring, performance analysis, project tracking, and competitive analysis, to name but a few. In general, large enterprises, corporations, agencies, institutions, and other organizations are facing a continuing problem of handling, processing, and/or accurately identifying data from various sources and help users/clients via various portals that are crucial to plan actions in an efficient and expedited manner, i.e., decision to buy or sell equity or stock in a timely manner, to improve overall user/client satisfaction, profit margins, and business performance.

Conventional trading tools lack the configuration and/or capabilities to provide insights to the timing of equity buys and sells visually in a small form factor (i.e., boxplot) with aggregated insights and indicators, and thereby fail to provide a user/client to make appropriate buy/sell decision with confidence. For example, common moving average plots generated by conventional trading tools lack details of historical statistics and insights for an individual (i.e., user or a client) to make a quick confidence decision on equity buys and sells.

Thus, there is a need for an advanced tool that can address these shortcomings of conventional trading tools.

### SUMMARY

The present disclosure, through one or more of its various aspects, embodiments, and/or specific features or sub-components, provides, among other features, various systems, servers, devices, methods, media, programs, and platforms for implementing a platform and language agnostic smart data processing module configured to formulate and allow visualization of insights data for stock or equity trading based on optimal histogram values data and machine learning confidence scores data, but the disclosure is not limited thereto. For example, the present disclosure, through one or more of its various aspects, embodiments, and/or specific features or sub-components, also provides, among other features, various systems, servers, devices, methods, media, programs, and platforms for implementing a platform and language smart data processing module configured to combine aggregated statistics of an equity moving average trends data, days in buy/sell cycles data, maximum or minimum price indicators, machine learning predications in a boxplot, thereby allowing an individual (i.e., user or a client) to provide input, via a user interface embedded within the smart data processing module, to make a quick confidence decision on equity buys and sells, but the disclosure is not limited thereto.

According to an aspect of the present disclosure, a method for generating a confidence score for trading an equity by utilizing one or more processors along with allocated memory is disclosed. The method may include: accessing a database that stores historical raw data of daily time series prices of an equity to be traded by a user via a user interface; invoking an application programming interface to receive the historical raw data from the database; transforming the received historical raw data into corresponding bear and bull cycles by applying a predefined technical indicator formulation algorithm to the received historical raw data; calculating days in group (DIG) values and histogram values for every bear and bull cycles associated with the equity; receiving new raw data associated with the equity; implementing a machine learning model that receives the calculated DIG values, the histogram values, the new raw data, and buy or sell labels as input and outputs a confidence score to buy or sell the equity; generating a boxplot digital display onto the user interface that displays the confidence score, the DIG values, and the histogram values; and receiving user input via the user interface to buy or sell the equity based on determining that the confidence score meets a predefined threshold value.

According to a further aspect of the present disclosure, wherein the predefined technical indicator formulation algorithm may include a pricing momentum formulation algorithm or a moving average convergence and divergence formulation algorithm, but the disclosure is not limited thereto.

According to another aspect of the present disclosure, wherein transforming the received historical raw data may further include generating a DIG data set, an optimal histogram value (OHV) data set, and an optimal net value (ONV) data set from the calculated DIG values.

According to yet another aspect of the present disclosure, the method may further include generating the boxplot digital display onto the user interface by combining the confidence score output from the machine learning model, the DIG data set, the OHV data set, and the ONV data set.

According to an aspect of the present disclosure, in generating the OHV data set, the method may further include: determining a minimum price of the equity in the bear cycle and the bear cycle's histogram value; and generating the OHV data set based on determining the minimum price and the bear cycle's histogram value.

According to a further aspect of the present disclosure, in generating the OHV data set, the method may further include: determining a maximum price of the equity in the bull cycle and the bull cycle's histogram value; and generating the OHV data set based on determining the maximum price and the bull cycle's histogram value.

According to another aspect of the present disclosure, in generating the ONV data set, the method may further include: determining a minimum price of the equity in the bear cycle; determining a maximum price of the equity in the bull cycle; calculating a difference between the maximum price and the minimum price as ONV per share; and generating the ONV data set based on the calculated difference.

According to yet another aspect of the present disclosure, wherein the histogram values may include the bull cycle's histogram value and the bear cycle's histogram value associated with the equity, but the disclosure is not limited thereto.

According to an aspect of the present disclosure, a system for generating a confidence score for trading an equity is disclosed. The system may include a processor; and a memory operatively connected to the processor via a communication interface, the memory storing computer readable instructions, when executed, may cause the processor to: access a database that stores historical raw data of daily time series prices of an equity to be traded by a user via a user interface; invoke an application programming interface to receive the historical raw data from the database; transform the received historical raw data into corresponding bear and bull cycles by applying a predefined technical indicator formulation algorithm to the received historical raw data; calculate days in group (DIG) values and histogram values for every bear and bull cycles associated with the equity; receive new raw data associated with the equity; implement a machine learning model that receives the calculated DIG values, the histogram values, the new raw data, and buy or sell labels as input and outputs a confidence score to buy or sell the equity; generate a boxplot digital display onto the user interface that displays the confidence score, the DIG values, and the histogram values; and receive user input via the user interface to buy or sell the equity based on determining that the confidence score meets a predefined threshold value.

According to a further aspect of the present disclosure, wherein in transforming the received historical raw data, the processor may be further configured to: generate a DIG data set, an optimal histogram value (OHV) data set, and an optimal net value (ONV) data set from the calculated DIG values.

According to an aspect of the present disclosure, wherein the processor may be further configured to: generate the boxplot digital display onto the user interface by combining the confidence score output from the machine learning model, the DIG data set, the OHV data set, and the ONV data set.

According to a further aspect of the present disclosure, in generating the OHV data set, the processor may be further configured to: determine a minimum price of the equity in the bear cycle and the bear cycle's histogram value; and generate the OHV data set based on determining the minimum price and the bear cycle's histogram value.

According to another aspect of the present disclosure, in generating the OHV data set, the processor may be further configured to: determine a maximum price of the equity in the bull cycle and the bull cycle's histogram value; and generate the OHV data set based on determining the maximum price and the bull cycle's histogram value.

According to an aspect of the present disclosure, in generating the ONV data set, the processor may be further configured to: determine a minimum price of the equity in the bear cycle; determine a maximum price of the equity in the bull cycle; calculate a difference between the maximum price and the minimum price as ONV per share; and generate the ONV data set based on the calculated difference.

According to a further aspect of the present disclosure, a non-transitory computer readable medium configured to store instructions for generating a confidence score for trading an equity is disclosed. The instructions, when executed, may cause a processor to perform the following: accessing a database that stores historical raw data of daily time series prices of an equity to be traded by a user via a user interface; invoking an application programming interface to receive the historical raw data from the database; transforming the received historical raw data into corresponding bear and bull cycles by applying a predefined technical indicator formulation algorithm to the received historical raw data; calculating days in group (DIG) values and histogram values for every bear and bull cycles associated with the equity; receiving new raw data associated with the equity; implementing a machine learning model that receives the calculated DIG values, the histogram values, the new raw data, and buy or sell labels as input and outputs a confidence score to buy or sell the equity; generating a boxplot digital display onto the user interface that displays the confidence score, the DIG values, and the histogram values; and receiving user input via the user interface to buy or sell the equity based on determining that the confidence score meets a predefined threshold value.

According to another aspect of the present disclosure, wherein in transforming the received historical raw data, the instructions, when executed, may further cause the processor to perform the following: generating a DIG data set, an optimal histogram value (OHV) data set, and an optimal net value (ONV) data set from the calculated DIG values.

According to yet another aspect of the present disclosure, the instructions, when executed, may further cause the processor to perform the following: generating the boxplot digital display onto the user interface by combining the confidence score output from the machine learning model, the DIG data set, the 01-IV data set, and the ONV data set.

According to an aspect of the present disclosure, in generating the OHV data set, the instructions, when executed, may further cause the processor to perform the following: determining a minimum price of the equity in the bear cycle and the bear cycle's histogram value; and generating the OHV data set based on determining the minimum price and the bear cycle's histogram value.

According to a further aspect of the present disclosure, in generating the OHV data set, the instructions, when executed, may further cause the processor to perform the following: determining a maximum price of the equity in the bull cycle and the bull cycle's histogram value; and generating the OHV data set based on determining the maximum price and the bull cycle's histogram value.

According to another aspect of the present disclosure, in generating the ONV data set, the instructions, when executed, may further cause the processor to perform the following: determining a minimum price of the equity in the bear cycle; determining a maximum price of the equity in the bull cycle; calculating a difference between the maximum price and the minimum price as ONV per share; and generating the ONV data set based on the calculated difference.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, and cloud agnostic smart data processing module configured to formulate and allow visualization of insights data for stock or equity trading based on optimal histogram values data and machine learning confidence scores data in accordance with an exemplary embodiment.

FIG. 2 illustrates an exemplary diagram of a network environment with a platform, language, and cloud agnostic smart data processing device in accordance with an exemplary embodiment.

FIG. 3 illustrates a system diagram for implementing a platform, language, and cloud agnostic smart data processing device having a platform, language, and cloud agnostic smart data processing module in accordance with an exemplary embodiment.

FIG. 4 illustrates a system diagram for implementing a platform, language, and cloud agnostic smart data processing module of FIG. 3 in accordance with an exemplary embodiment.

FIG. 5 illustrates an exemplary chart implemented by the platform, language, and cloud agnostic smart data processing module of FIG. 4 in accordance with an exemplary embodiment.

FIG. 6 illustrates an exemplary flow diagram for formulating raw data to insight data sets implemented by the platform, language, and cloud agnostic smart data processing module of FIG. 4 in accordance with an exemplary embodiment.

FIG. 7 illustrates an exemplary boxplot with optimal histogram value implemented by the platform, language, and cloud agnostic smart data processing module of FIG. 4 in accordance with an exemplary embodiment.

FIG. 8 illustrates an exemplary chart with data set, new raw data and exemplary days of histogram trends implemented by the platform, language, and cloud agnostic smart data processing module of FIG. 4 in accordance with an exemplary embodiment.

FIG. 9 illustrates an exemplary boxplot that combines boxplot optimal histogram value with new histogram values generated by the platform, language, and cloud agnostic smart data processing module of FIG. 4 in accordance with an exemplary embodiment.

FIG. 10A illustrates first exemplary boxplot of optimal histogram value system of insights generated by the platform, language, and cloud agnostic smart data processing module of FIG. 4 in accordance with an exemplary embodiment.

FIG. 10B illustrates second exemplary boxplot of optimal histogram value system of insights generated by the platform, language, and cloud agnostic smart data processing module of FIG. 4 in accordance with an exemplary embodiment.

FIG. 10C illustrates third exemplary boxplot of optimal histogram value system of insights generated by the platform, language, and cloud agnostic smart data processing module of FIG. 4 in accordance with an exemplary embodiment.

FIG. 11 illustrates an exemplary block diagram implemented by the platform, language, and cloud agnostic smart data processing module of FIG. 4 for machine learning and training in accordance with an exemplary embodiment.

FIG. 12 illustrates an exemplary block diagram implemented by the platform, language, and cloud agnostic smart data processing module of FIG. 4 for machine learning prediction in accordance with an exemplary embodiment.

FIG. 13 illustrates an exemplary boxplot with optimal days in group and optimal net values generated by the platform, language, and cloud agnostic smart data processing module of FIG. 4 in accordance with an exemplary embodiment.

FIG. 14 illustrates another exemplary boxplot with additional information generated by the platform, language, and cloud agnostic smart data processing module of FIG. 4 in accordance with an exemplary embodiment.

FIG. 15 illustrates another exemplary boxplot with optimal histogram value system of insights generated by the platform, language, and cloud agnostic smart data processing module of FIG. 4 in accordance with an exemplary embodiment.

FIG. 16 illustrates an exemplary use case for mobile display with compact boxplot of optimal histogram value system implemented by the platform, language, and cloud agnostic smart data processing module of FIG. 4 in accordance with an exemplary embodiment.

FIG. 17 illustrates another exemplary use case for screening equites with boxplot of optimal histogram value system implemented by the platform, language, and cloud agnostic smart data processing module of FIG. 4 in accordance with an exemplary embodiment.

FIG. 18 illustrates an exemplary flow chart implemented by the platform, language, and cloud agnostic smart data processing module of FIG. 4 for formulating and allowing visualization of insights data for stock or equity trading based on optimal histogram values data and machine learning confidence scores data in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

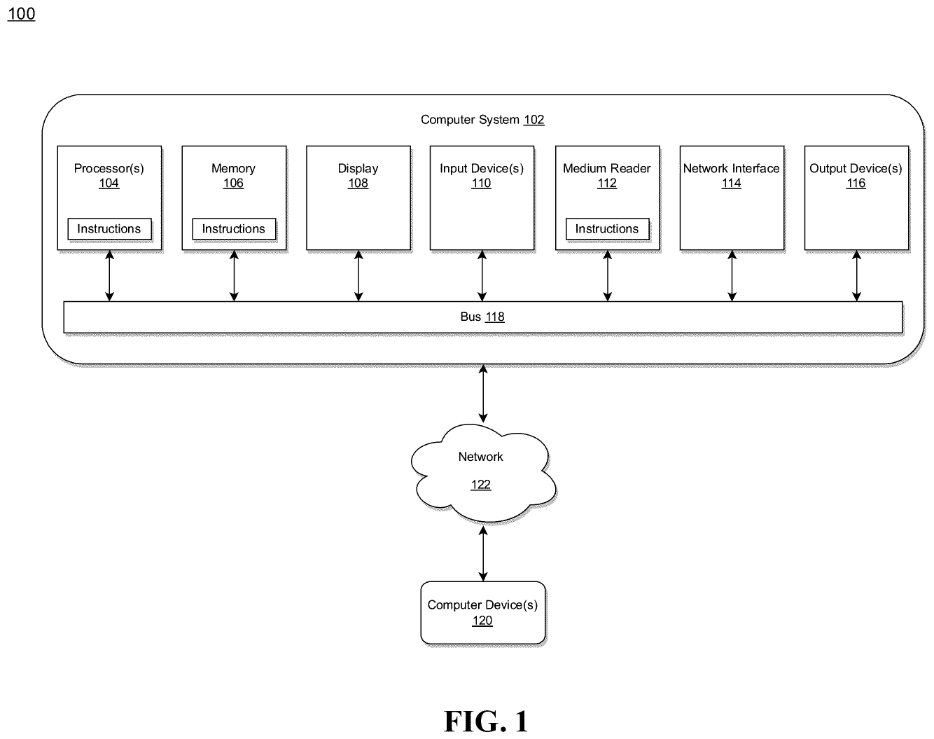

FIG. 1 is an exemplary system 100 for use in implementing a platform, language, and cloud agnostic smart data processing module configured to formulate and allow visualization of insights data for stock or equity trading based on optimal histogram values data and machine learning confidence scores data in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the smart data processing module may be platform, language, and cloud agnostic that may allow for consistent easy orchestration and passing of data through various components to output a desired result regardless of platform, language, and cloud environment. Since the disclosed process, according to exemplary embodiments, is platform, language, and cloud agnostic, the smart data processing module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

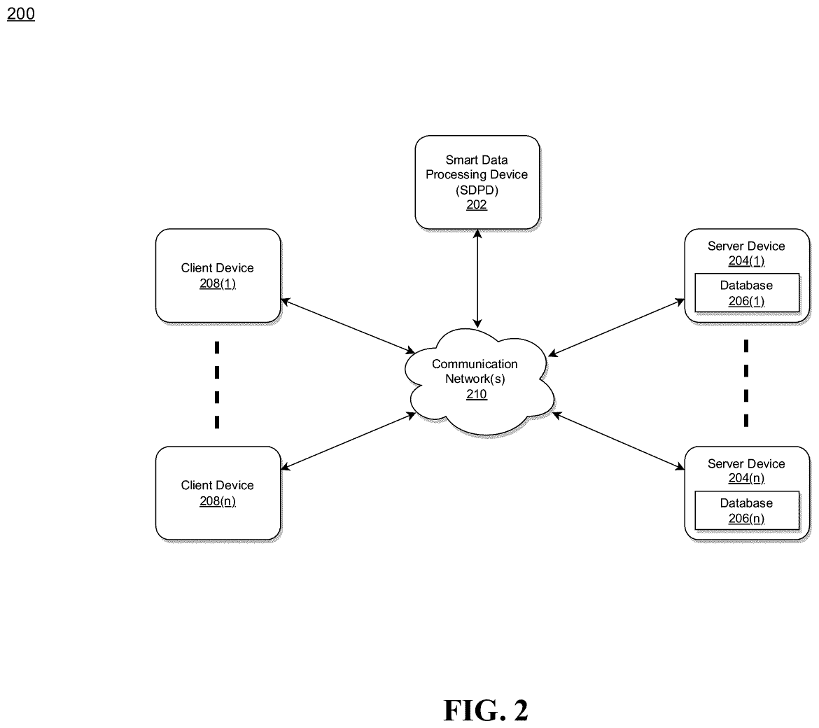

Referring to FIG. 2, a schematic of an exemplary network environment 200 for implementing a language, platform, and cloud agnostic smart data processing device (SDPD) of the instant disclosure is illustrated.

According to exemplary embodiments, the above-described problems associated with conventional tools may be overcome by implementing an SDPD 202 as illustrated in FIG. 2 that may be configured for implementing a platform, language, and cloud agnostic smart data processing module configured to formulate and allow visualization of insights data for stock or equity trading based on optimal histogram values data and machine learning confidence scores data, but the disclosure is not limited thereto. For example, according to exemplary embodiments, the above-described problems associated with conventional tools may be overcome by implementing the SDPD 202 as illustrated in FIG. 2 that may be configured for implementing a platform, cloud, and language smart data processing module configured to combine aggregated statistics of an equity moving average trends data, days in buy/sell cycles data, maximum or minimum price indicators, machine learning predications in a boxplot, thereby allowing an individual (i.e., user or a client) to provide input, via a user interface embedded within the smart data processing module, to make a quick confidence decision on equity buys and sells, but the disclosure is not limited thereto.

The SDPD 202 may be the same or similar to the computer system 102 as described with respect to FIG. 1.

The SDPD 202 may store one or more applications that can include executable instructions that, when executed by the SDPD 202, cause the SDPD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SDPD 202 itself, may be located in virtual server(s) running in a cloud-based computing environment rather than being tied to one or more specific physical network computing devices. Also, the application(s) may be running in one or more virtual machines (VMs) executing on the SDPD 202. Additionally, in one or more embodiments of this technology, virtual machine(s) running on the SDPD 202 may be managed or supervised by a hypervisor.

In the network environment 200 of FIG. 2, the SDPD 202 is coupled to a plurality of server devices 204(1)-204(n) that hosts a plurality of databases 206(1)-206(n), and also to a plurality of client devices 208(1)-208(n) via communication network(s) 210. A communication interface of the SDPD 202, such as the network interface 114 of the computer system 102 of FIG. 1, operatively couples and communicates between the SDPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SDPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SDPD 202 may be a standalone device or integrated with one or more other devices or apparatuses, such as one or more of the server devices 204(1)-204(n), for example. In one particular example, the SDPD 202 may be hosted by one of the server devices 204(1)-204(n), and other arrangements are also possible. Moreover, one or more of the devices of the SDPD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SDPD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the SDPD 202 that may efficiently provide a platform for implementing a platform, cloud, and language agnostic smart data processing module configured to formulate and allow visualization of insights data for stock or equity trading based on optimal histogram values data and machine learning confidence scores data, but the disclosure is not limited thereto. For example, according to exemplary embodiments, the client devices 208(1)-208(n) in this example may include any type of computing device that can facilitate the implementation of the SDPD 202 that may efficiently provide a platform for implementing a platform and language smart data processing module configured to combine aggregated statistics of an equity moving average trends data, days in buy/sell cycles data, maximum or minimum price indicators, machine learning predications in a boxplot, thereby allowing an individual (i.e., user or a client) to provide input, via a user interface embedded within the smart data processing module, to make a quick confidence decision on equity buys and sells, but the disclosure is not limited thereto.

The client devices 208(1)-208(n) may run interface applications, such as standard web browsers or standalone client applications, which may provide an interface to communicate with the SDPD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SDPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SDPD 202, the server devices 204(1)-204(n), or the client devices 208(1)-208(n), for example, may be configured to operate as virtual instances on the same physical machine. For example, one or more of the SDPD 202, the server devices 204(1)-204(n), or the client devices 208(1)-208(n) may operate on the same physical device rather than as separate devices communicating through communication network(s) 210. Additionally, there may be more or fewer SDPDs 202, server devices 204(1)-204(n), or client devices 208(1)-208(n) than illustrated in FIG. 2. According to exemplary embodiments, the SDPD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

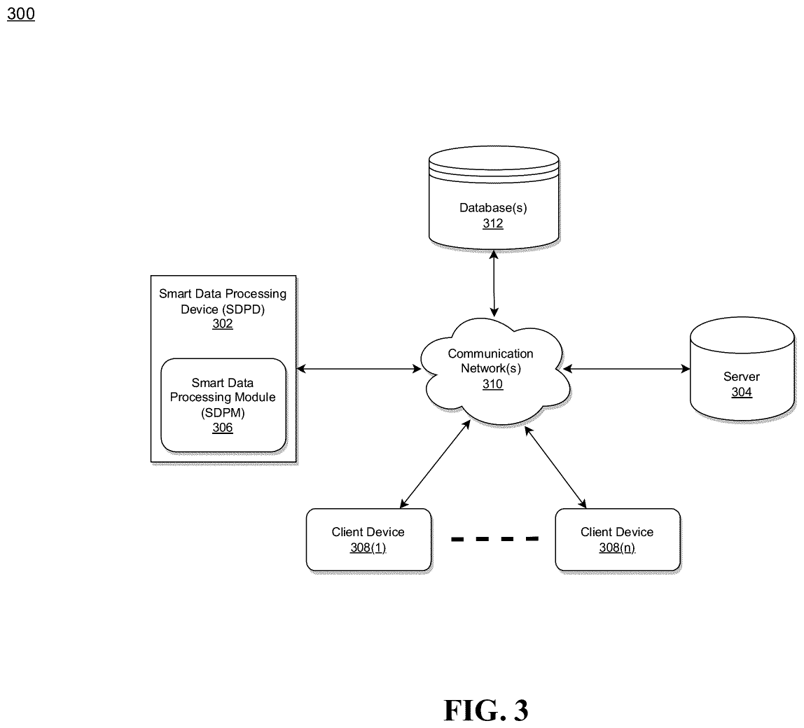

FIG. 3 illustrates a system diagram for implementing a platform, language, and cloud agnostic SDPD having a platform, language, and cloud agnostic smart data processing module (SDPM) in accordance with an exemplary embodiment.

As illustrated in FIG. 3, the system 300 may include a SDPD 302 within which an SDPM 306 is embedded, a server 304, a database(s) 312, a plurality of client devices 308(1) . . . 308(n), and a communication network 310.

According to exemplary embodiments, the SDPD 302 including the SDPM 306 may be connected to the server 304, and the database(s) 312 via the communication network 310. The SDPD 302 may also be connected to the plurality of client devices 308(1) . . . 308(n) via the communication network 310, but the disclosure is not limited thereto.

According to exemplary embodiment, the SDPD 302 is described and shown in FIG. 3 as including the SDPM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the SDPM 306 may be configured to receive real-time feed of data from the plurality of client devices 308(1) . . . 308(n) and secondary sources via the communication network 310.

As may be described below, the SDPM 306 may be configured to: access a database that stores historical raw data of daily time series prices of an equity to be traded by a user via a user interface; invoke an application programming interface to receive the historical raw data from the database; transform the received historical raw data into corresponding bear and bull cycles by applying a predefined technical indicator formulation algorithm to the received historical raw data; calculate days in group (DIG) values and histogram values for every bear and bull cycles associated with the equity; receive new raw data associated with the equity; implement a machine learning model that receives the calculated DIG values, the histogram values, the new raw data, and buy or sell labels as input and outputs a confidence score to buy or sell the equity; generate a boxplot digital display onto the user interface that displays the confidence score, the DIG values, and the histogram values; and receive user input via the user interface to buy or sell the equity based on determining that the confidence score meets a predefined threshold value, but the disclosure is not limited thereto.

The plurality of client devices 308(1) . . . 308(n) are illustrated as being in communication with the SDPD 302. In this regard, the plurality of client devices 308(1) . . . 308(n) may be “clients” (e.g., customers) of the SDPD 302 and are described herein as such. Nevertheless, it is to be known and understood that the plurality of client devices 308(1) . . . 308(n) need not necessarily be “clients” of the SDPD 302, or any entity described in association therewith herein. Any additional or alternative relationship may exist between either or both of the plurality of client devices 308(1) . . . 308(n) and the SDPD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the SDPD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SDPD 302 may be the same or similar to the SDPD 202 as described with respect to FIG. 2, including any features or combination of features described with respect thereto.

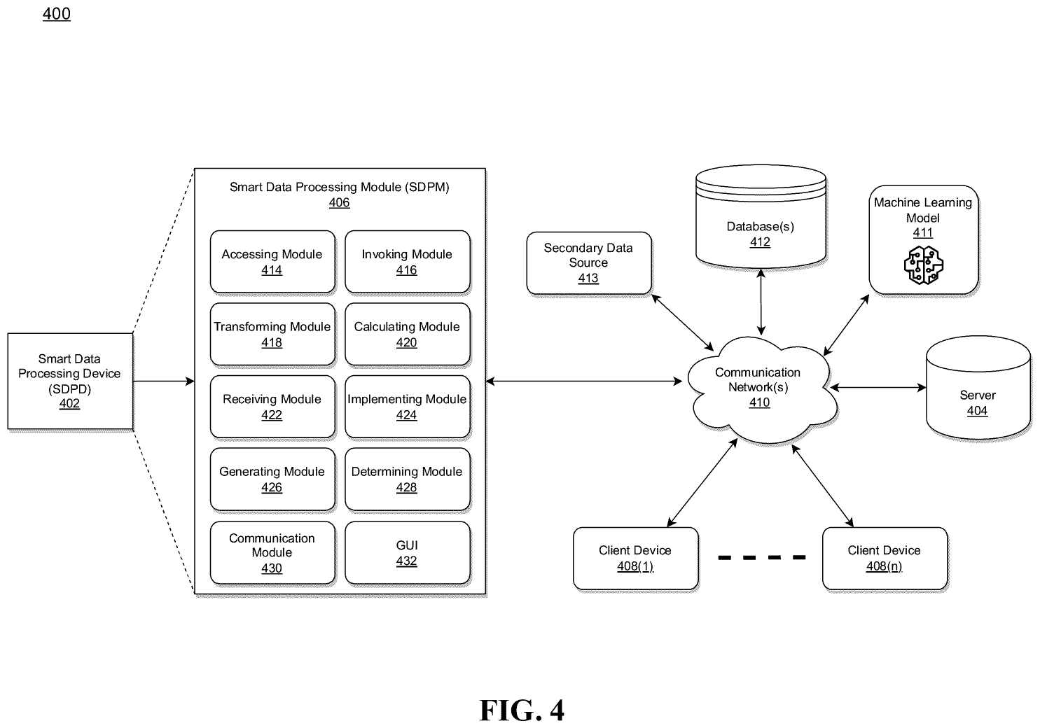

FIG. 4 illustrates a system diagram for implementing a platform, language, and cloud agnostic SDPM of FIG. 3 in accordance with an exemplary embodiment.

According to exemplary embodiments, the system 400 may include a platform, language, and cloud agnostic SDPD 402 within which a platform, language, and cloud agnostic SDPM 406 is embedded, a server 404, database(s) 412, a communication network 410, a machine learning model 411, and a secondary data source 413 (one or more).

According to exemplary embodiments, the SDPD 402 including the SDPM 406 may be connected to the server 404, the machine learning model 411, the secondary data source 413, and the database(s) 412 via the communication network 410. The SDPD 402 may also be connected to the plurality of client devices 408(1)-408(n) via the communication network 410, but the disclosure is not limited thereto. The SDPM 406, the server 404, the plurality of client devices 408(1)-408(n), the database(s) 412, the communication network 410 as illustrated in FIG. 4 may be the same or similar to the SDPM 306, the server 304, the plurality of client devices 308(1)-308(n), the database(s) 312, the communication network 310, respectively, as illustrated in FIG. 3.

According to exemplary embodiments, as illustrated in FIG. 4, the SDPM 406 may include an accessing module 414, an invoking module 416, a transforming module 418, a calculating module 420, a receiving module 422, an implementing module 424, a generating module 426, a determining module 428, a communication module 430, and a graphical user interface (GUI) 432. According to exemplary embodiments, interactions and data exchange among these modules included in the SDPM 406 provide the advantageous effects of the disclosed invention. Functionalities of each module of FIG. 4 may be described in detail below with reference to FIGS. 4-18.

According to exemplary embodiments, each of the accessing module 414, invoking module 416, transforming module 418, calculating module 420, receiving module 422, implementing module 424, generating module 426, determining module 428, and the communication module 430 of the SDPM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the accessing module 414, invoking module 416, transforming module 418, calculating module 420, receiving module 422, implementing module 424, generating module 426, determining module 428, and the communication module 430 of the SDPM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the accessing module 414, invoking module 416, transforming module 418, calculating module 420, receiving module 422, implementing module 424, generating module 426, determining module 428, and the communication module 430 of the SDPM 406 of FIG. 4 may be implemented by dedicated hardware, or as a combination of dedicated hardware to perform some functions and a processor (e.g., one or more programmed microprocessors and associated circuitry) to perform other functions.

According to exemplary embodiments, each of the accessing module 414, invoking module 416, transforming module 418, calculating module 420, receiving module 422, implementing module 424, generating module 426, determining module 428, and the communication module 430 of the SDPM 406 of FIG. 4 may be called via corresponding API.

According to exemplary embodiments, the process implemented by the SDPM 406 may be executed via the communication module 430 and the communication network 410, which may comprise plural networks as described above. For example, in an exemplary embodiment, the various components of the SDPM 406 may communicate with the server 404, and the database(s) 412 via the communication module 430 and the communication network 410. Of course, these embodiments are merely exemplary and are not limiting or exhaustive. The database(s) 412 may include the databases included within the private cloud and/or public cloud and the server 404 may include one or more servers within the private cloud and the public cloud.

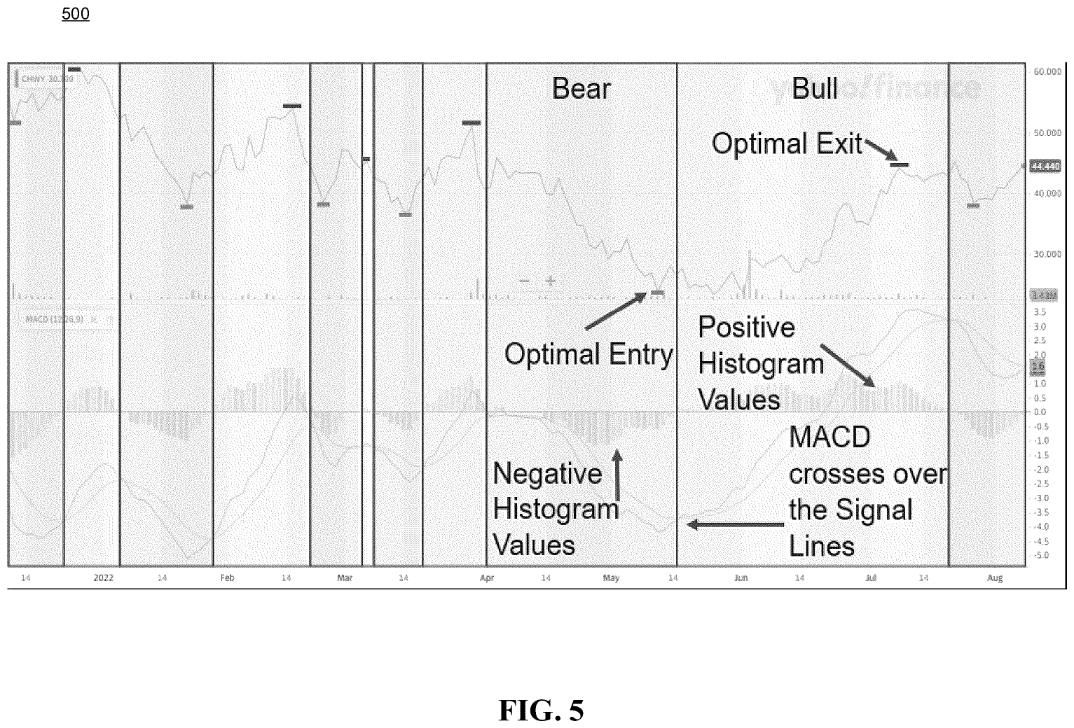

According to exemplary embodiments, the accessing module 414 may be configured to access the database(s) 412 that stores historical raw data of daily time series prices of an equity (i.e., CHWY as will be discussed with FIGS. 5-17 below) to be traded by a user via a user interface (i.e., GUI 432). The invoking module 416 may be configured to invoke an application programming interface (API) to receive the historical raw data from the database(s) 412. The transforming module 418 may be configured to transform the received historical raw data into corresponding bear cycle of a bear market and a bull cycle of a bull market by applying a predefined technical indicator formulation algorithm to the received historical raw data.

According to exemplary embodiments, a bear market may represent a market when such market experiences prolonged price declines. It typically describes a condition in which securities prices may fall 20% or more from recent highs amid widespread pessimism and negative investor sentiment. As it is understood by an ordinary skill in the art, bear markets are often associated with declines in an overall market or index like the S&P 500, but individual securities or commodities can also be considered to be in a bear market if they experience a decline of 20% or more over a sustained period of time—typically two months or more. Bear markets also may accompany general economic downturns such as a recession. Bear markets may be contrasted with upward-trending bull markets.

According to exemplary embodiments, a bull market may be a period of time in financial markets when the price of an asset or security rises continuously. The commonly accepted definition of a bull market is when stock prices rise by 20% after two declines of 20% each. A bull market may represent a condition of a financial market in which prices are rising or are expected to rise. As it is understood by an ordinary skill in the art, the term “bull market” is most often used to refer to the stock market but can be applied to anything that is traded, such as bonds, real estate, currencies, and commodities. Because prices of securities rise and fall essentially continuously during trading, the term “bull market” is typically reserved for extended periods in which a large portion of security prices are rising. Bull markets tend to last for months or even years.

According to exemplary embodiments, the calculating module 420 may be configured to calculate days in group (DIG) values and histogram values for every bear and bull cycles associated with the equity.

According to exemplary embodiments, the predefined technical indicator formulation algorithm may include a pricing momentum formulation algorithm or a moving average convergence and divergence (MACD) formulation algorithm, but the disclosure is not limited thereto.

FIG. 5 illustrates an exemplary chart 500 implemented by the platform, language, and cloud agnostic SDPM 406 of FIG. 4 in accordance with an exemplary embodiment. As illustrated in FIG. 5, the raw historical day closing price data for an equity (i.e., CHWY) from late December 2021 to August 2022 is plotted where in the bear market, optimal entity and negative histogram values are illustrated as well as in the bull market, optimal exit point, positive histogram values and MACD crosses over the signal lines are illustrated. This CHWY chart 500 is sectioned by the bear and bull cycles and the respective optimal entry (light grey line in the bear cycle) and exit (dark grey line in the bull cycle) points. The bottom half of the chart 500 shows the two lines (MACD and signal) crossing as indicating the boundaries between the bull and bear cycles.

According to exemplary embodiments, the historical daily time series prices of a common stock may be the primary source of raw data feed in to the SDPM 406. An exemplary technical indicator formulation, i.e., MACD transform the raw data into useful pricing trends and bear and bull cycles, but the disclosure is not limited thereto. For example, the SDPM 406 may utilize other pricing momentum formulation such as the Schaff Trend Cycle instead of MACD indicator.

According to exemplary embodiments, the SDPM 406 can accommodate a plurality of secondary source 413 of input data to formulate a well balance of insights without over complicating the digital display for clear interpretations. According to exemplary embodiments, the secondary data can be about the consumer sentiment of the stock/equity, about inflation, about unemployment rate or custom institutional data. For example, any data that is relevant to the investment objectives can be displayed onto the GUI 432.

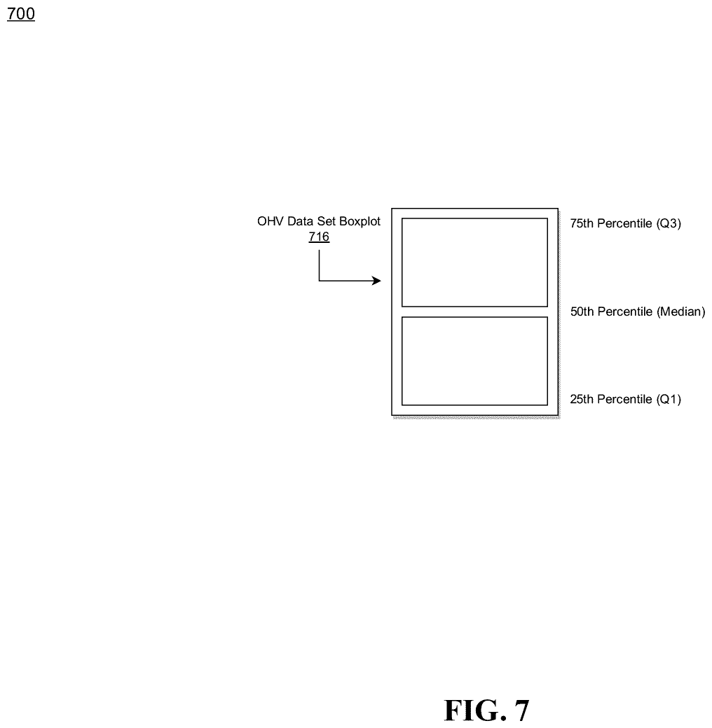

According to exemplary embodiments, the SDPM 406 may capture all data, information insights, and present them on a common boxplot annotated with directional arrows, and color-coded bear/bull cycle indicators. The boxplot can be compact in size to accommodate various digital displays and expanded to full size with all the information details, see e.g., FIGS. 7-17.

According to exemplary embodiments, the receiving module 422 may be configured to receive new raw data associated with the equity. The implementing module 424 may be configured to implement the machine learning model 411 that receives the calculated DIG values, the histogram values, the new raw data, and buy or sell labels as input and outputs a confidence score to buy or sell the equity. The generating module 426 may be configured to generate a boxplot digital display onto the user interface that displays the confidence score, the DIG values, and the histogram values. The receiving module 422 may be further configured to receive user input via the GUI 432 to buy or sell the equity based on determining, by the determining module 428, that the confidence score meets a predefined threshold value.

According to exemplary embodiments, wherein in transforming the received historical raw data by the transforming module 418, the generating module 426 may be configured to generate a DIG data set, an optimal histogram value (OHV) data set, and an optimal net value (ONV) data set from the calculated DIG values. According to exemplary embodiments, the SDPM 406 may also be referred to herein as boxplot OHV system of insights.

According to exemplary embodiments, the generating module 426 may be further configured to generate the boxplot digital display onto the user interface by combining the confidence score output from the machine learning model, the DIG data set, the OHV data set, and the ONV data set.

According to exemplary embodiments, in generating the OHV data set by the generating module 426, the determining module 428 may be configured to determine a minimum price of the equity in the bear cycle and the bear cycle's histogram value; and the generating module 426 may be configured to generate the OHV data set based on determining by the determining module 428 the minimum price and the bear cycle's histogram value.

According to exemplary embodiments, in generating the OHV data set by the generating module 426, the determining module 428 may be further configured to determine a maximum price of the equity in the bull cycle and the bull cycle's histogram value; and the generating module 426 may be configured to generate the OHV data set based on determining by the determining module 428 the maximum price and the bull cycle's histogram value.

According to exemplary embodiments, in generating the ONV data set by the generating module 426, the determining module 428 may be further configured to determine a minimum price of the equity in the bear cycle; and determine a maximum price of the equity in the bull cycle. The calculating module 420 may be configured to calculate a difference between the maximum price and the minimum price as ONV per share; and the generating module 426 may be further configured to generate the ONV data set based on the calculated difference.

According to exemplary embodiments, the SDPM 406 may be configured to process real-time streaming data received from the database(s) 412 and the secondary data source 413. Moreover, the SDPM 406 may be further configured to execute end of day batch processing of a bulk requests from users to generate boxplot as disclosed herein.

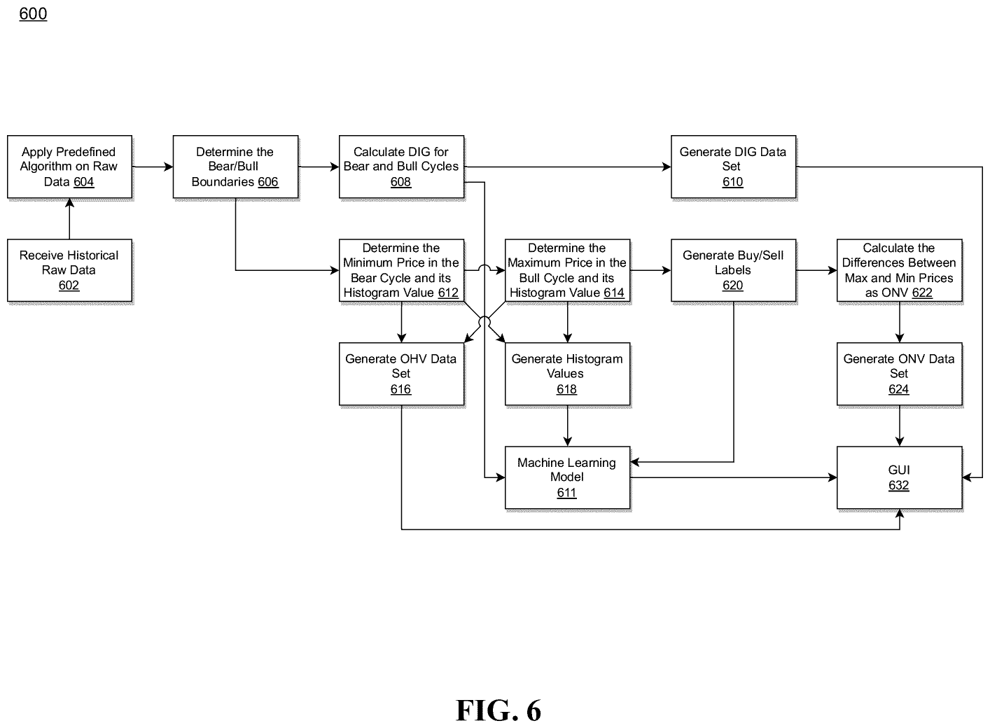

FIG. 6 illustrates an exemplary flow diagram 600 for formulating raw data to insight data sets implemented by the platform, language, and cloud agnostic SDPM 406 of FIG. 4 in accordance with an exemplary embodiment. For example, at step 602 of the flow diagram 600, the system (i.e., SDPM 406) may receive historical raw data. At step 604, predefined algorithm (i.e., MACD) may be applied to the raw data. At step 606, the bear and bull boundaries are determined based on the raw data and from the exemplary boxplot as illustrated in the chart 500 of FIG. 5. At step 608, DIG for bear and bull cycles may be calculated. A step 610, DIG data set may be generated based on the calculated DIG for bear and bull cycles. At step 612, based on the determined bear and bull boundaries at step 606, minimum price in the bear cycles and its histogram values are determined. At step 614, maximum price in the bull cycles and its histogram value are determined. At step 616, OHV data set are generated based on the determined minimum price in the bear and bull cycles and their corresponding histogram values. At step 618, histogram values are generated that include both the bear cycle's histogram value from step 612 and the bull cycle's histogram value from step 614. At step 620, buy and/or sell labels are generated based on the determined minimum price in the bear and bull cycles and their corresponding histogram values. At step 622, differences between maximum and minimum prices are calculated as ONV. At step 624, ONV data set is generated based on the calculated ONV at step 622.

As illustrated in FIG. 6, the machine learning model 611 may receive the calculated DIGs for bear and bull cycles calculated at step 608, generated histogram values that include both the bear cycle's histogram value from step 612 and the bull cycle's histogram value from step 614, and the buy and/or sell labels generated in step 620.

According to exemplary embodiments, the GUI 632 may display a boxplot digital display that includes the OHV data set, the output (i.e., confidence score) from the machine learning model 611, the DIG data set and the ONV data set, but the disclosure is not limited thereto.

FIG. 7 illustrates an exemplary boxplot 700 with OHV implemented by the platform, language, and cloud agnostic SDPM 406 of FIG. 4 in accordance with an exemplary embodiment. As illustrated in FIG. 7, the exemplary boxplot 700 illustrates an OHV data set boxplot 716. As illustrated in FIG. 7, an MACD histogram measures the vertical distance between the MACD line and its signal line. A positive MACD histogram value is considered the bull cycle, and a negative MACD histogram value is considered the bear cycle. The MACD histogram is zero when the MACD and signal lines touch each other. The MACD histogram also provides an indication of the bull/bear trends reversal when the value goes from a positive to a negative or from a negative to a positive.

According to exemplary embodiments, as illustrated in FIG. 7, the OHV for many bear/bull cycles contribute to making this boxplot. One can then observe and gain insights for a new histogram value in comparison to the OHV distribution range.

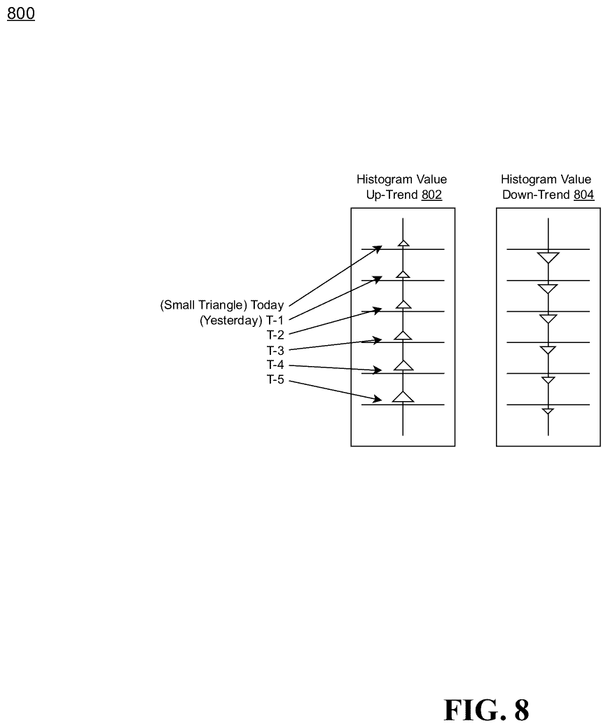

FIG. 8 illustrates an exemplary chart 800 with data set, new raw data and exemplary days of histogram trends implemented by the platform, language, and cloud agnostic SDPM 406 of FIG. 4 in accordance with an exemplary embodiment. As illustrated in FIG. 8, The SDPM 406 takes the latest (6) days of MACD histogram values to provide the insights and the anticipation of the imminent change in the bull/bear trends. One can select more days or less days, but six days appears to be a balance without crowding the digital display onto the GUI 432, 632. Conditions when the small triangle may be shown with a larger triangle. An upward pointing large triangle is an additional indicator of today's equity price has reached the highest value since the start of cycle. A downward pointing large triangle indicates today's equity price has reached the lowest value since the start of the cycle. For example, FIG. 8, shows histogram value up-trend 802 and histogram value down-trend 804.

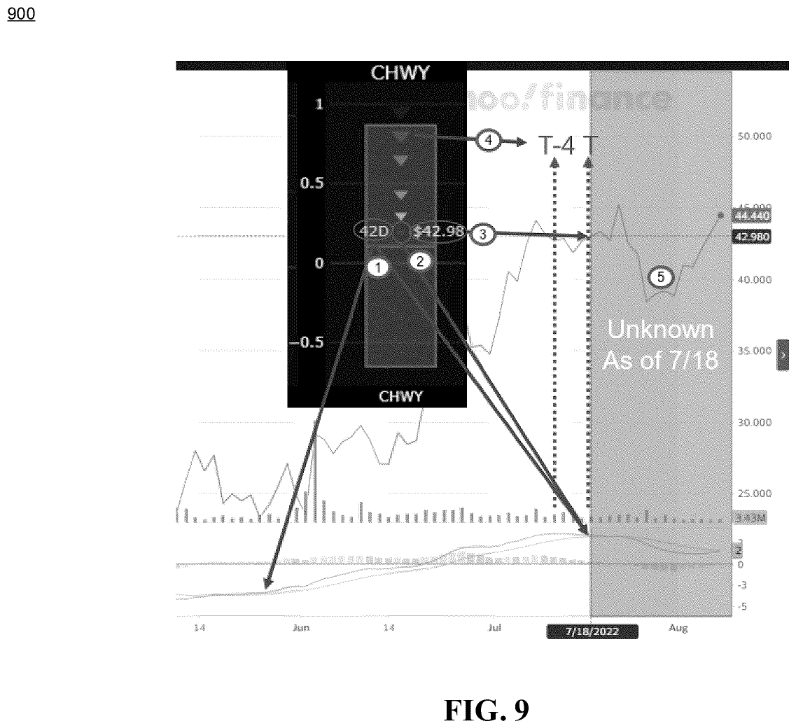

FIG. 9 illustrates an exemplary boxplot 900 that combines boxplot OHV with new histogram values implemented by the platform, language, and cloud agnostic SDPM 406 of FIG. 4 in accordance with an exemplary embodiment. FIG. 9 illustrates and exemplary equity (i.e., CHWY) boxplot histogram insights. For example, CHWY Boxplot for 7/18/2022 is shown with equivalent MACD chart. (1) CHWY is 42 days in the bull cycle. (2) A normal sized triangle heading towards zero. (3) The normal sized triangle indicates the price on Jul. 18, 2022 is not the lowest or the highest compared to previous 41 days in the bull period. (4) Early insight to sell the equity was triggered at T-4 and continued to T (Jul. 18, 2022). That was when the histogram value decreased at T-4 to below the Q3 boundary value. According to exemplary embodiments, the boxplot color (i.e., different shades of grey) also changed to for visual indication. (5) Fast forward beyond T and it may be ascertained that the stock price decreased further confirming the early insights to sell.

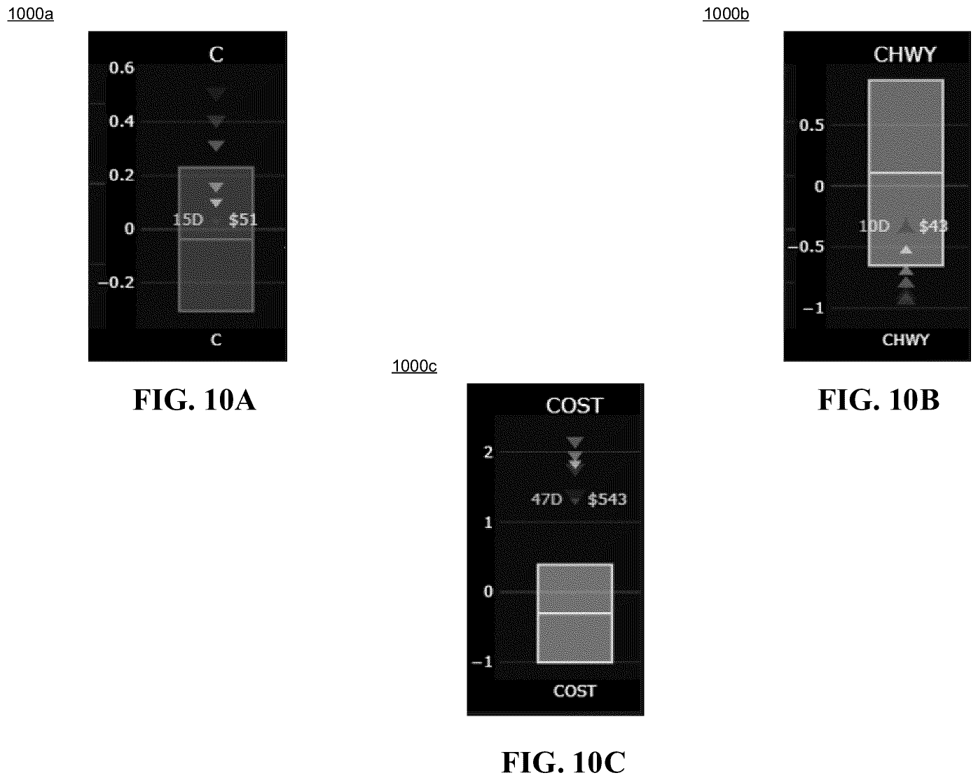

FIG. 10A illustrates first exemplary boxplot 1000a of optimal histogram value system of insights implemented by the platform, language, and cloud agnostic SDPM 406 of FIG. 4 in accordance with an exemplary embodiment. As illustrated in the boxplot 1000a, C is 15 days in the bull cycle with decreasing histogram values heading to zero. The histogram at T-2 triggered a Sell insight with the light gray rectangular visual clue.

FIG. 10B illustrates second exemplary boxplot 1000b of optimal histogram value system of insights implemented by the platform, language, and cloud agnostic SDPM 406 of FIG. 4 in accordance with an exemplary embodiment. As illustrated in the boxplot 1000b, the CHWY is 10 days in the bear cycle with negative histogram values trending upwards to zero. The histogram triggered a Buy insight at T-2 crossing Q1 with a light grey rectangular visual clue. A large grey triangle at T indicates highest price since the start of the cycle 10 days ago indicating that perhaps not an optimal time to buy.

FIG. 10C illustrates third exemplary boxplot 1000c of optimal histogram value system of insights implemented by the platform, language, and cloud agnostic s SDPM 406 of FIG. 4 in accordance with an exemplary embodiment. As illustrated in the boxplot 1000c, another equity (i.e., COST) is 47 days in the bull cycle with downward trending histogram values, but has not crossed the Q3 boundary to provide any sell insights. Boxplot remains in grey color.

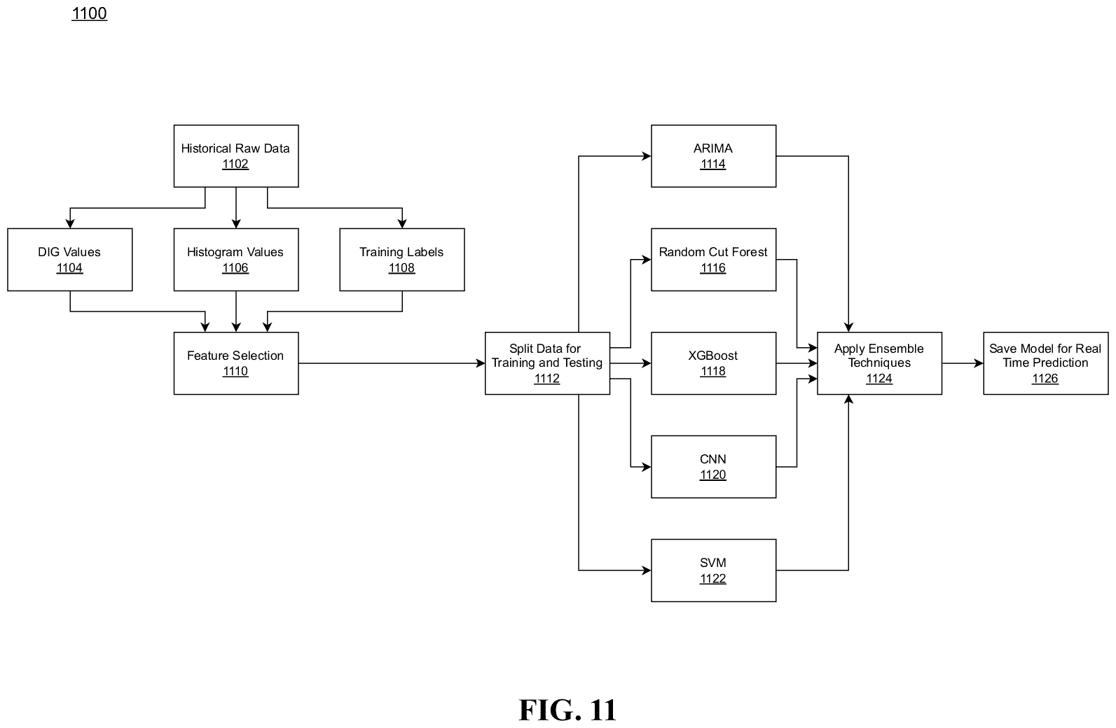

FIG. 11 illustrates an exemplary block diagram 1100 implemented by the platform, language, and cloud agnostic SDPM 406 of FIG. 4 for machine learning and training in accordance with an exemplary embodiment. As illustrated in FIG. 11, historical raw data 1102 may be utilized to generate DIG values 1104, histogram values 1106, and training labels 1108. Feature selection 1110 may be made based on the DIG values 1104, histogram values 1106, and training labels 1108. The machine learning model 411 as illustrated in FIG. 4 can utilize the feature selection 1110 for splitting data for training and testing the machine learning model 411. According to exemplary embodiments, data can be split into ARIMA (Autoregressive Integrated Moving Average) 1114, random cut forest 1116, XGBoost (Extreme Gradient Boost) 1118, CNN (Convolutional Neural Network) 1120, and SVM (Support-Vector Machine) 1122.

According to exemplary embodiments, in statistics and econometrics, and in particular in time series analysis, an ARIMA 1114 model is a generalization of an autoregressive moving average model. Both of these models are fitted to time series data either to better understand the data or to predict future points in the series.

According to exemplary embodiments, random cut forest 1116 is an algorithm for detecting anomalous data points within a data set. These are observations which diverge from otherwise well-structured or patterned data. Anomalies can manifest as unexpected spikes in time series data, breaks in periodicity, or unclassifiable data points. They are easy to describe in that, when viewed in a plot, they are often easily distinguishable from the “regular” data.

According to exemplary embodiments, XGBoost 1118 is an open-source software library which provides a regularizing gradient boosting framework for C++, Java, Python, R, Julia, Perl, and Scala. It works on Linux, Windows, and macOS. From the project description, it aims to provide a “Scalable, Portable and Distributed Gradient Boosting Library”.

According to exemplary embodiments, CNN 1120 is, in deep machine learning, a class of artificial neural network, most commonly applied to analyze visual imagery.

According to exemplary embodiments, SVM 1122, in machine learning, is supervised learning models with associated learning algorithms that analyze data for classification and regression analysis.

As illustrated in FIG. 11, ensemble techniques 1124 may be applied to the machine learning model 411 based on output from ARIMA 1114, random cut forest 1116, XGBoost 1118, CNN 1120, and SVM 1122. The SDPM 406 then may save the machine learning model for real time prediction 1126.

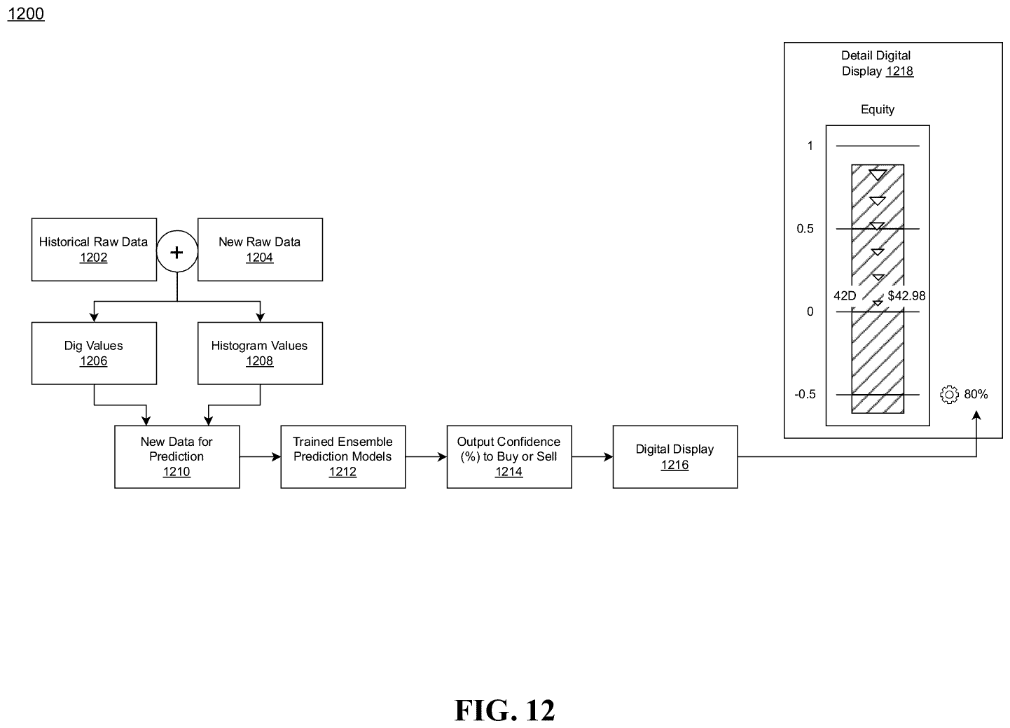

FIG. 12 illustrates an exemplary block diagram 1200 implemented by the platform, language, and cloud agnostic SDPM 406 of FIG. 4 for machine learning prediction in accordance with an exemplary embodiment. As illustrated in FIG. 12, historical raw data 1202 and new raw data 1204 may be combined and DIG values 1206 and histogram values 1208 may be generated based on the combined historical raw data 1202 and new raw data 1204. New data for prediction 1210 may be made based on the DIG values 1206 and the histogram values 1208. Ensemble prediction models 1212 may be trained based on the new data for prediction 1210. The machine learning model 411 (as illustrated in FIG. 4) may output confidence score (i.e., percentage (%)) to buy or sell 1214. The digital display 1216 (i.e., embedded within the GUI 432 as illustrated in FIG. 4) may display detail digital display 1218 with the confidence score (i.e., 80%) so that one can decide with confidence whether to buy or sell an equity.

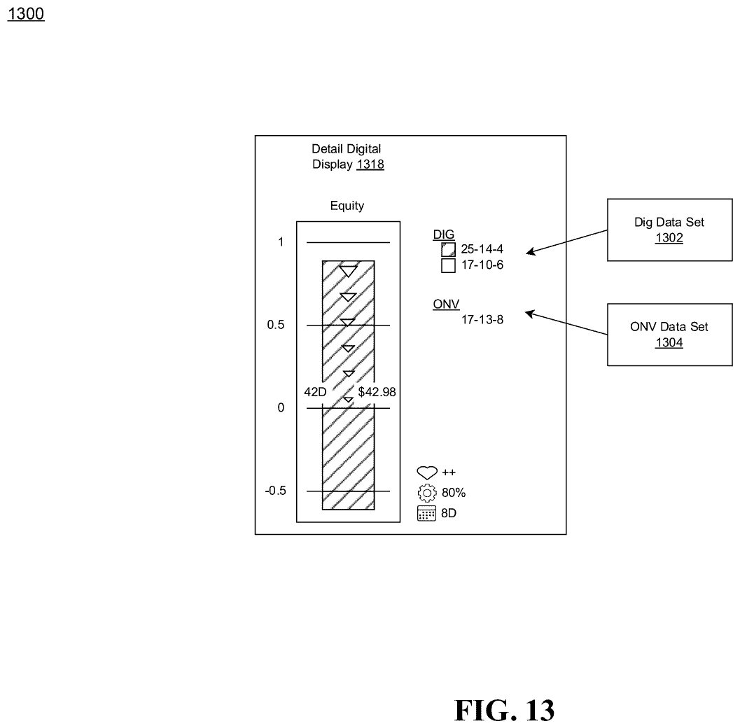

FIG. 13 illustrates an exemplary boxplot 1300 with optimal days in group and ONVs implemented by the platform, language, and cloud agnostic SDPM 406 of FIG. 4 in accordance with an exemplary embodiment. FIG. 13 illustrates the same equity boxplot from FIG. 5 with DIG and ONVs. These insight values are represented in percentiles of 75-50-25 ranges. Both DIG and ONV percentiles use data from the recent twelve sets of bear/bull cycles. It is a configurable parameter to a higher number of sets for more general distribution or a lower number of sets for more specific distribution insights. As illustrated in FIG. 13, the detail digital display 1318 illustrates detail view of DIG data set 1302 and ONV data set 1304.

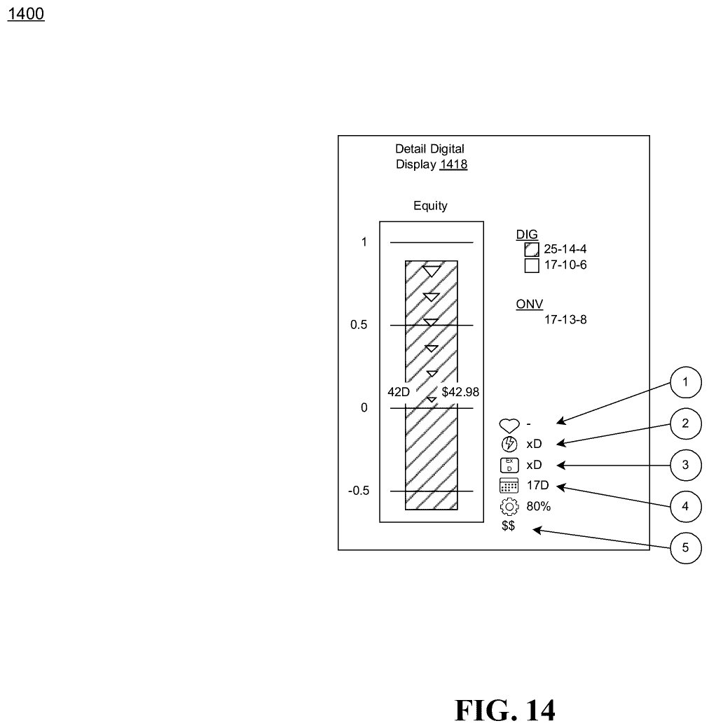

FIG. 14 illustrates another exemplary boxplot 1400 with additional information implemented by the platform, language, and cloud agnostic SDPM 406 of FIG. 4 in accordance with an exemplary embodiment. FIG. 14 illustrates the same equity (i.e., CHWY) boxplot from FIG. 5 with additional information related to the equity/stock. 1) The heart relates to consumer sentiment about the stock on social media in the past 6 days. Each − (negative) or + (positive) symbol represents 25%. A total of four symbol for 100%. CHWY's sentiment is (−25%). 2) The split is the number of days to the announced stock split. CHWY has no stock split scheduled. 3) The ex-dividend is the number of days to the announced ex-dividend date. CHWY has no plans offering a dividend. 4) The earning calendar is the number of days to the earning announcement. CHWY has an earning announcement in 17 days after the market closed (Da). (Db) for before market open. 5) The double dollar sign is clickable and links to the brokage firm to initiate a stock transaction.

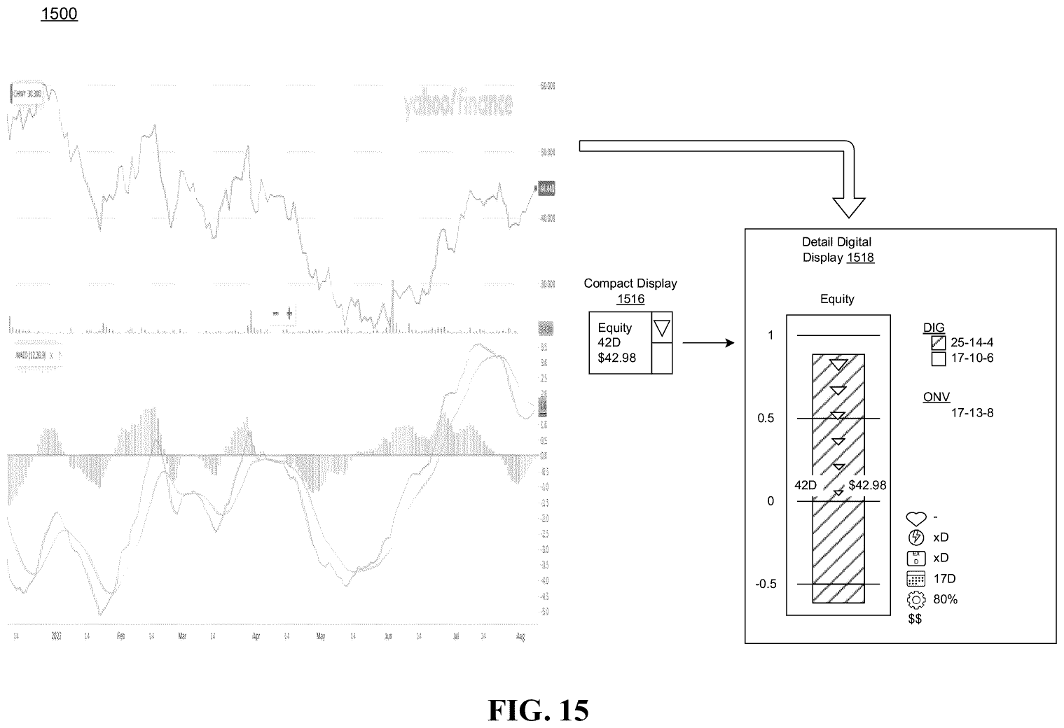

FIG. 15 illustrates another exemplary boxplot 1500 with OHV system of insights generated by the platform, language, and cloud agnostic SDPM 406 of FIG. 4 in accordance with an exemplary embodiment. The CHEWY chart in the boxplot 1500 shows the daily price (top) and the MACD lines (bottom). It is time consuming to perform the technical analysis and predict the optimal entry and exit points with a level of confidence. The SDPM 409 as disclosed herein provides insights and the confidence to make the optimal equity buys and sells.

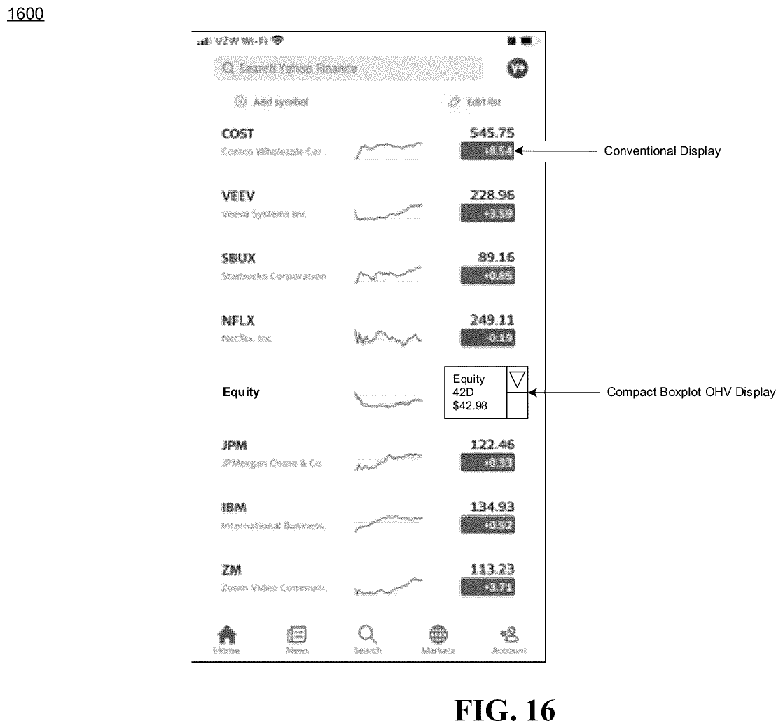

FIG. 16 illustrates an exemplary use case 1600 for mobile display with compact boxplot of OHV system generated by the platform, language, and cloud agnostic SDPM 406 of FIG. 4 in accordance with an exemplary embodiment. An example of how the compact Boxplot OHV is displayed next to the conventional price information. The Boxplot OHV provides more insights on the equity. As evident from the compact Boxplot OHV, CHWY is 42 days in the bull cycle trending downward and in the optimal Q3 histogram zone. One can infer from this Boxplot OHV that CHWY is a candidate to sell the equity. Alternatively, stock ticker tape with compact boxplot OHV may also be generated as another exemplary use case. The ticker tape may prove to be a good use case for the compact Boxplot OHV indication.

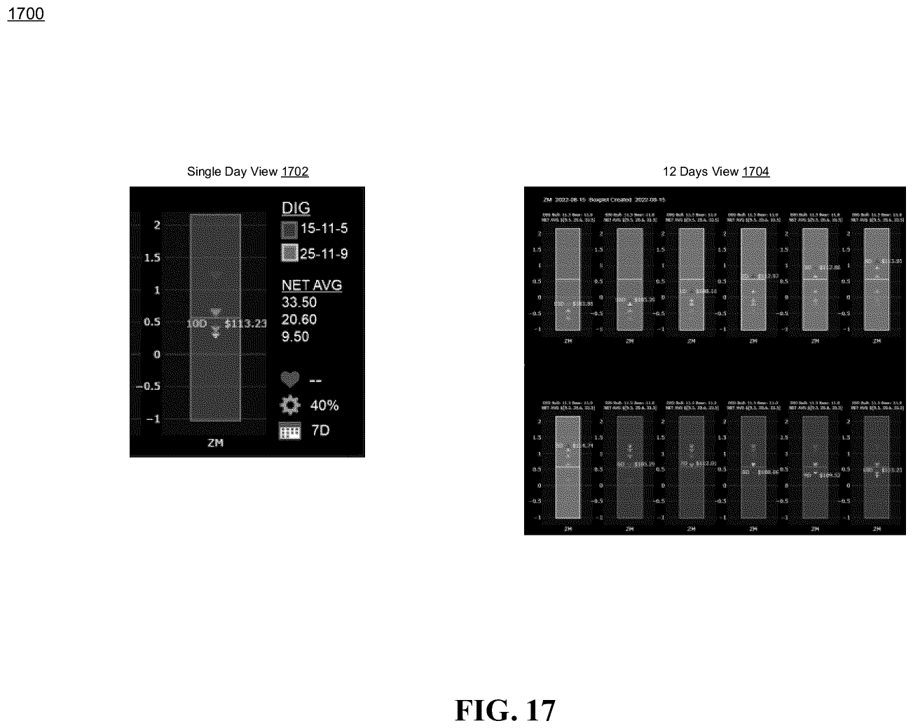

FIG. 17 illustrates another exemplary use case 1700 for screening equites with boxplot of optimal histogram value system implemented by the platform, language, and cloud agnostic SDPM 406 of FIG. 4 in accordance with an exemplary embodiment. For example, a grouped view of 39 stock symbols (not shown) to quickly identify which stocks are in the zone for closer examination. One can see four stocks are in the bull cycles to sell and one stock is in the bear cycle to buy. One can also drill-down to see more days of the same stocks or single day for more insights. The program can be configured to screen many more stocks and just see the ones that are in the zones. FIG. 17 illustrates a single day view 1702 or 12 days view 1704.

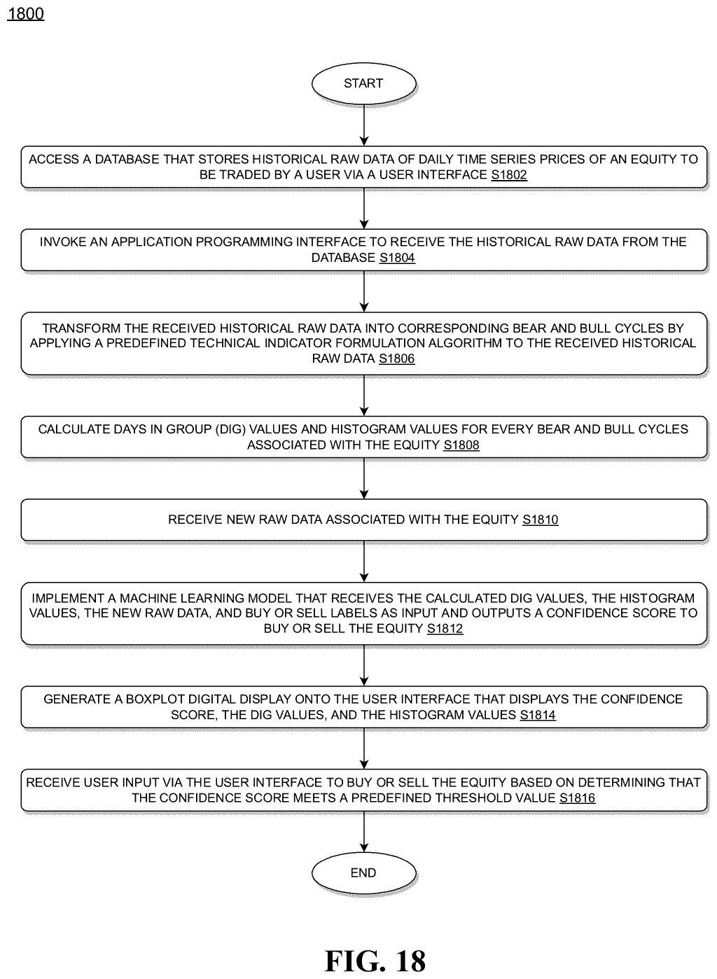

FIG. 18 illustrates an exemplary flow chart 1800 implemented by the platform, language, and cloud agnostic SDPM 406 of FIG. 4 for formulating and allowing visualization of insights data for stock or equity trading based on optimal histogram values data and machine learning confidence scores data in accordance with an exemplary embodiment. It may be appreciated that the illustrated process 1800 and associated steps may be performed in a different order, with illustrated steps omitted, with additional steps added, or with a combination of reordered, combined, omitted, or additional steps.

As illustrated in FIG. 18, at step S1802, the process 1800 may include accessing a database that stores historical raw data of daily time series prices of an equity to be traded by a user via a user interface.

At step S1804, the process 1800 may include invoking an API to receive the historical raw data from the database.

At step S1806, the process 1800 may include transforming the received historical raw data into corresponding bear and bull cycles by applying a predefined technical indicator formulation algorithm to the received historical raw data.

At step S1808, the process 1800 may include calculating days in group (DIG) values and histogram values for every bear and bull cycles associated with the equity.

At step S1810, the process 1800 may include receiving new raw data associated with the equity.

At step S1812, the process 1800 may include implementing a machine learning model that receives the calculated DIG values, the histogram values, the new raw data, and buy or sell labels as input and outputs a confidence score to buy or sell the equity.

At step S1814, the process 1800 may include generating a boxplot digital display onto the user interface that displays the confidence score, the DIG values, and the histogram values.

At step S1816, the process 1800 may include receiving user input via the user interface to buy or sell the equity based on determining that the confidence score meets a predefined threshold value.

According to exemplary embodiments, in the process 1800, the predefined technical indicator formulation algorithm may include a pricing momentum formulation algorithm or a moving average convergence and divergence formulation algorithm, but the disclosure is not limited thereto.

According exemplary embodiments, in transforming the received historical raw data, the process 1800 may further include generating a DIG data set, an optimal histogram value (OHV) data set, and an optimal net value (ONV) data set from the calculated DIG values.

According to exemplary embodiments, process 1800 may further include generating the boxplot digital display onto the user interface by combining the confidence score output from the machine learning model, the DIG data set, the OHV data set, and the ONV data set.

According to exemplary embodiments, in generating the OHV data set, the process 1800 may further include: determining a minimum price of the equity in the bear cycle and the bear cycle's histogram value; and generating the OHV data set based on determining the minimum price and the bear cycle's histogram value.

According to exemplary embodiments, in generating the OHV data set, the process 1800 may further include: determining a maximum price of the equity in the bull cycle and the bull cycle's histogram value; and generating the OHV data set based on determining the maximum price and the bull cycle's histogram value.

According to exemplary embodiments, in generating the ONV data set, the process 1800 may further include: determining a minimum price of the equity in the bear cycle; determining a maximum price of the equity in the bull cycle; calculating a difference between the maximum price and the minimum price as ONV per share; and generating the ONV data set based on the calculated difference.

According to exemplary embodiments, in the process 1800, the histogram values may include the bull cycle's histogram value and the bear cycle's histogram value associated with the equity, but the disclosure is not limited thereto.

According to exemplary embodiments, the SDPD 402 may include a memory (e.g., a memory 106 as illustrated in FIG. 1) which may be a non-transitory computer readable medium that may be configured to store instructions for implementing a platform, language, and cloud agnostic SDPM 406 for generating a confidence score for trading an equity as disclosed herein. The SDPD 402 may also include a medium reader (e.g., a medium reader 112 as illustrated in FIG. 1) which may be configured to read any one or more sets of instructions, e.g., software, from any of the memories described herein. The instructions, when executed by a processor embedded within the SDPM 406 within the SDPD 402, may be used to perform one or more of the methods and processes as described herein. In a particular embodiment, the instructions may reside completely, or at least partially, within the memory 106, the medium reader 112, and/or the processor 104 (see FIG. 1) during execution by the SDPD 402.

According to exemplary embodiments, the instructions, when executed, may cause a processor embedded within the SDPM 406 or the SDPD 402 to perform the following: accessing a database that stores historical raw data of daily time series prices of an equity to be traded by a user via a user interface; invoking an application programming interface to receive the historical raw data from the database; transforming the received historical raw data into corresponding bear and bull cycles by applying a predefined technical indicator formulation algorithm to the received historical raw data; calculating days in group (DIG) values and histogram values for every bear and bull cycles associated with the equity; receiving new raw data associated with the equity; implementing a machine learning model that receives the calculated DIG values, the histogram values, the new raw data, and buy or sell labels as input and outputs a confidence score to buy or sell the equity; generating a boxplot digital display onto the user interface that displays the confidence score, the DIG values, and the histogram values; and receiving user input via the user interface to buy or sell the equity based on determining that the confidence score meets a predefined threshold value. According to exemplary embodiments, the processor may be the same or similar to the processor 104 as illustrated in FIG. 1 or the processor embedded within SDPD 202, SDPD 302, SDPD 402, and SDPM 406.

According to exemplary embodiments, in transforming the received historical raw data, the instructions, when executed, may further cause the processor 104 to perform the following: generating a DIG data set, an optimal histogram value (OHV) data set, and an optimal net value (ONV) data set from the calculated DIG values.

According to exemplary embodiments, the instructions, when executed, may further cause the processor 104 to perform the following: generating the boxplot digital display onto the user interface by combining the confidence score output from the machine learning model, the DIG data set, the OHV data set, and the ONV data set.

According to exemplary embodiments, in generating the OHV data set, the instructions, when executed, may further cause the processor 104 to perform the following: determining a minimum price of the equity in the bear cycle and the bear cycle's histogram value; and generating the OHV data set based on determining the minimum price and the bear cycle's histogram value.

According to exemplary embodiments, in generating the OHV data set, the instructions, when executed, may further cause the processor 104 to perform the following: determining a maximum price of the equity in the bull cycle and the bull cycle's histogram value; and generating the OHV data set based on determining the maximum price and the bull cycle's histogram value.

According to exemplary embodiments, in generating the ONV data set, the instructions, when executed, may further cause the processor 104 to perform the following: determining a minimum price of the equity in the bear cycle; determining a maximum price of the equity in the bull cycle; calculating a difference between the maximum price and the minimum price as ONV per share; and generating the ONV data set based on the calculated difference.

According to exemplary embodiments as disclosed above in FIGS. 1-18, technical improvements effected by the instant disclosure may include a platform for implementing a platform, cloud, and language agnostic smart data processing module configured to formulate and allow visualization of insights data for stock or equity trading based on optimal histogram values data and machine learning confidence scores data, but the disclosure is not limited thereto. For example, according to exemplary embodiments as disclosed above in FIGS. 1-18, technical improvements effected by the instant disclosure may also include a platform for implementing a platform, cloud, and language agnostic smart data processing module configured to combine aggregated statistics of an equity moving average trends data, days in buy/sell cycles data, maximum or minimum price indicators, machine learning predications in a boxplot, thereby allowing an individual (i.e., user or a client) to provide input, via a user interface embedded within the smart data processing module, to make a quick confidence decision on equity buys and sells, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for generating a confidence score for trading an equity by utilizing one or more processors along with allocated memory, the method comprising:
implementing a smart data processing module (SDPM) configured to formulate and allow visualization of insights data for stock or equity trading based on optimal histogram values data and machine learning confidence scores data, wherein the SDPM is platform, language, and cloud agnostic that results consistent easy orchestration and passing of data through various components to output a desired result regardless of platform, language, and cloud environment, wherein the SDPM includes an accessing module, an invoking module, a transforming module, a calculating module, a receiving module, an implementing module, and a generating module, each module being called via corresponding application programming interface (API);
accessing, by calling the accessing module via a first API, a database that stores historical raw data of daily time series prices of an equity to be traded by a user via a user interface;
invoking, by calling the invoking module via a second API, an application programming interface to receive the historical raw data from the database;
transforming, by calling the transforming module via a third API, the received historical raw data into corresponding bear and bull cycles by applying a predefined technical indicator formulation algorithm to the received historical raw data;
calculating, by calling the calculating module via a fourth API, days in group (DIG) values and histogram values for every bear and bull cycles associated with the equity;
receiving, by calling the receiving module via a fifth API, new raw data associated with the equity;
implementing, by calling the implementing module via a sixth API, a machine learning model that receives the calculated DIG values, the histogram values, the new raw data, and buy or sell labels as input and outputs a confidence score to buy or sell the equity;
generating, by calling the generating module via a seventh API, a boxplot digital display onto the user interface that displays the confidence score, the DIG values, and the histogram values; and
receiving user input via the user interface to buy or sell the equity based on determining that the confidence score meets a predefined threshold value.

2. The method according to claim 1, wherein the predefined technical indicator formulation algorithm includes a pricing momentum formulation algorithm or a moving average convergence and divergence formulation algorithm.

3. The method according to claim 1, wherein transforming the received historical raw data further comprising:
generating a DIG data set, an optimal histogram value (OHV) data set, and an optimal net value (ONV) data set from the calculated DIG values.

4. The method according to claim 3, further comprising:
generating the boxplot digital display onto the user interface by combining the confidence score output from the machine learning model, the DIG data set, the OHV data set, and the ONV data set.

5. The method according to claim 3, in generating the OHV data set, the method further comprising:
determining a minimum price of the equity in the bear cycle and the bear cycle's histogram value; and
generating the OHV data set based on determining the minimum price and the bear cycle's histogram value.

6. The method according to claim 3, in generating the OHV data set, the method further comprising:
determining a maximum price of the equity in the bull cycle and the bull cycle's histogram value; and
generating the OHV data set based on determining the maximum price and the bull cycle's histogram value.

7. The method according to claim 3, in generating the ONV data set, the method further comprising:
determining a minimum price of the equity in the bear cycle;
determining a maximum price of the equity in the bull cycle;
calculating a difference between the maximum price and the minimum price as ONV per share; and
generating the ONV data set based on the calculated difference.

8. The method according to claim 1, wherein the histogram values include the bull cycle's histogram value and the bear cycle's histogram value associated with the equity.

9. A system for generating a confidence score for trading an equity, the system comprising:
a processor; and
a memory operatively connected to the processor via a communication interface, the memory storing computer readable instructions, when executed, causes the processor to:
implement a smart data processing module (SDPM) configured to formulate and allow visualization of insights data for stock or equity trading based on optimal histogram values data and machine learning confidence scores data, wherein the SDPM is platform, language, and cloud agnostic that results consistent easy orchestration and passing of data through various components to output a desired result regardless of platform, language, and cloud environment, wherein the SDPM includes an accessing module, an invoking module, a transforming module, a calculating module, a receiving module, an implementing module, and a generating module, each module being called via corresponding application programming interface (API);
access, by calling the accessing module via a first API, a database that stores historical raw data of daily time series prices of an equity to be traded by a user via a user interface;
invoke, by calling the invoking module via a second API, an application programming interface to receive the historical raw data from the database;
transform, by calling the transforming module via a third API, the received historical raw data into corresponding bear and bull cycles by applying a predefined technical indicator formulation algorithm to the received historical raw data;
calculate, by calling the calculating module via a fourth API, days in group (DIG) values and histogram values for every bear and bull cycles associated with the equity;
receive, by calling the receiving module via a fifth API, new raw data associated with the equity;
implement, by calling the implementing module via a sixth API, a machine learning model that receives the calculated DIG values, the histogram values, the new raw data, and buy or sell labels as input and outputs a confidence score to buy or sell the equity;
generate, by calling the generating module via a seventh API, a boxplot digital display onto the user interface that displays the confidence score, the DIG values, and the histogram values; and
receive user input via the user interface to buy or sell the equity based on determining that the confidence score meets a predefined threshold value.

10. The system according to claim 9, wherein the predefined technical indicator formulation algorithm includes a pricing momentum formulation algorithm or a moving average convergence and divergence formulation algorithm.

11. The system according to claim 9, wherein in transforming the received historical raw data, the processor is further configured to:
generate a DIG data set, an optimal histogram value (OHV) data set, and an optimal net value (ONV) data set from the calculated DIG values.

12. The system according to claim 11, wherein the processor is further configured to:
generate the boxplot digital display onto the user interface by combining the confidence score output from the machine learning model, the DIG data set, the OHV data set, and the ONV data set.

13. The system according to claim 11, in generating the OHV data set, the processor is further configured to:
determine a minimum price of the equity in the bear cycle and the bear cycle's histogram value; and
generate the OHV data set based on determining the minimum price and the bear cycle's histogram value.

14. The system according to claim 11, in generating the OHV data set, the processor is further configured to:
determine a maximum price of the equity in the bull cycle and the bull cycle's histogram value; and
generate the OHV data set based on determining the maximum price and the bull cycle's histogram value.

15. The system according to claim 11, in generating the ONV data set, the processor is further configured to:
determine a minimum price of the equity in the bear cycle;
determine a maximum price of the equity in the bull cycle;
calculate a difference between the maximum price and the minimum price as ONV per share; and
generate the ONV data set based on the calculated difference.

16. The system according to claim 9, wherein the histogram values include the bull cycle's histogram value and the bear cycle's histogram value associated with the equity.

17. A non-transitory computer readable medium configured to store instructions for generating a confidence score for trading an equity, the instructions, when executed, cause a processor to perform the following:
implementing a smart data processing module (SDPM) configured to formulate and allow visualization of insights data for stock or equity trading based on optimal histogram values data and machine learning confidence scores data, wherein the SDPM is platform, language, and cloud agnostic that results consistent easy orchestration and passing of data through various components to output a desired result regardless of platform, language, and cloud environment, wherein the SDPM includes an accessing module, an invoking module, a transforming module, a calculating module, a receiving module, an implementing module, and a generating module, each module being called via corresponding application programming interface (API);
accessing, by calling the accessing module via a first API, a database that stores historical raw data of daily time series prices of an equity to be traded by a user via a user interface;
invoking, by calling the invoking module via a second API, an application programming interface to receive the historical raw data from the database;
transforming, by calling the transforming module via a third API, the received historical raw data into corresponding bear and bull cycles by applying a predefined technical indicator formulation algorithm to the received historical raw data;
calculating, by calling the calculating module via a fourth API, days in group (DIG) values and histogram values for every bear and bull cycles associated with the equity;
receiving, by calling the receiving module via a fifth API, new raw data associated with the equity;
implementing, by calling the implementing module via a sixth API, a machine learning model that receives the calculated DIG values, the histogram values, the new raw data, and buy or sell labels as input and outputs a confidence score to buy or sell the equity;
generating, by calling the generating module via a seventh API, a boxplot digital display onto the user interface that displays the confidence score, the DIG values, and the histogram values; and
receiving user input via the user interface to buy or sell the equity based on determining that the confidence score meets a predefined threshold value.

18. The non-transitory computer readable medium according to claim 17, wherein the predefined technical indicator formulation algorithm includes a pricing momentum formulation algorithm or a moving average convergence and divergence formulation algorithm.

19. The non-transitory computer readable medium according to claim 17, wherein in transforming the received historical raw data, the instructions, when executed, further cause the processor to perform the following:
generating a DIG data set, an optimal histogram value (OHV) data set, and an optimal net value (ONV) data set from the calculated DIG values.

20. The non-transitory computer readable medium according to claim 19, wherein the instructions, when executed, further cause the processor to perform the following:
generating the boxplot digital display onto the user interface by combining the confidence score output from the machine learning model, the DIG data set, the OHV data set, and the ONV data set.
